(19) United States
(12) Patent Application Publication
(10) Pub. No.: US 2018/0105262 A1
(43) Pub. Date: Apr. 19, 2018

(54) AIRCRAFT SILENCING SYSTEM

(71) Applicant: brandon nedelman, Oceanside, CA (US)

(72) Inventor: brandon nedelman, Oceanside, CA (US)

(73) Assignee: UNITED STATES OF AMERICA AS REPRESENTED BY THE SECRETARY OF THE OF THE NAVY

(21) Appl. No.: 15/783,601

(22) Filed: Oct. 13, 2017

(51) Int. Cl. B64C 27/00; B64C 13/04

(52) U.S. Cl. CPC B64C 27/00; B64C 13/04

(57) ABSTRACT

A helicopter silencing system incorporating two muffler assemblies mounted surrounding the body and propeller areas of the aircraft so as to reduce and dampen outputted sound to silence the aircraft.

The cockpit contains, or otherwise being contained at a remote location, exists, a switch (pushbutton), for causing and initiating a response so that the two installed muffler assemblies discharge from the aircraft via electromechanical means.

The construction of each muffler assembly comprises two installable pieces comprising multiple mufflers so shaped to formate around the majority of the helicopter body, extending upward at curvature or angular formations, surrounding portions of the propeller.

The invention is a continuation in part of pct/us17/15916 in regards to the portion relating to military aircraft silencing via baffle barrels, otherwise known as sound dampening mufflers.

### DESCRIPTION OF DRAWINGS

The following describes the embodiments and drawings further contained within this document;

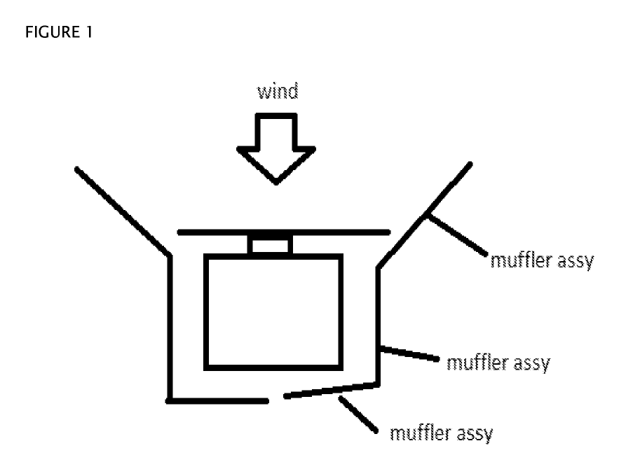

A. FIG. 1: assembly w/ cliffed application from transition of components from body portion-to-propeller covered portion.

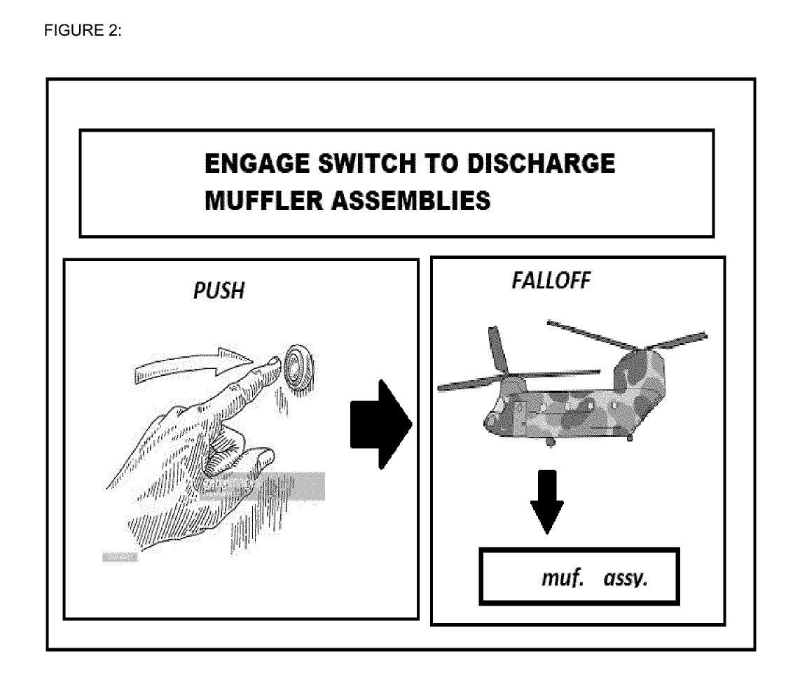

B. FIG. 2: push-button-remote-controlled disengagement of fall off pieces

### TECHNICAL DESCRIPTION

### Background Art

In prior art, mufflers are used to cover an enclosed pipe to reduce sound such as a firearm or exhaust pipe.

Exception: In this invention, mufflers or muffler assemblies are used to surround a wind sound epicenter of noise wind production on an aircraft, specifically a helicopter.

The helicopter is not an enclosed pipe source of sound. It is open, however, the epicenter of sound wave production produced by the helicopter is enclosed or partially enclosed within the range of its distance, covering the open noise phenomenon and thus reducing or dampening its audible sound with muffling.

Differing from the Previous Application:

The previous application as referenced called for a muffler above the propeller. This is absent in this invention because it is not needed, both because it can reduce the velocity and performance of th3e chopper, and there it no need to block the sound in the upward direction.

Two Piece Assembly:

This invention calls for only two assembled “pieces”. The pieces can be remotely electromechanically engaged to fall off and disassemble from the helicopter or aircraft when so engaged via a remote switch or responsive component, either located inside, or away from the flying aircraft. See FIG. 2.

The feature of only two assembled pieces makes installation convenient and cheap.

The technical problem and solution of this invention is cheap and effective silencing of specifically helicopter aircraft in military solutions. Other silent aircraft means are often expensive and do not apply specifically to helicopters.

Technical Description:

The invention is a sound dampening system for a helicopter comprising two assembled muffler assembly pieces that surround most of the helicopter and contain muffling “baffle barrels” to reduce the sound.

Mounting:

The invention is mounted or assembled around the sides of the helicopter body and propeller, excluding the top area of the helicopter directly located above the propeller.

Surround:

The assembly surrounds the sides, perpendicular bottom area of the helicopter, portion of the front of the helicopter (excluding the front of the windshield which is needed to see for the pilot (on manned aircraft applications)), back of the helicopter. The assembly is two pieces, parallelly constructed and assembled to be mounted as two components. The components may snap into place into the “electromechanically disengage able “fall off” mechanism. The assemblies also “cliff” or “v” around/surrounding a portion of the area surrounding the propeller, which is necessary for the two-piece construction and application of this invention, this means that the invention extends at an angle or curve “around” the area necessary for extension of space. See FIG. 1, where the assembly extends at a “v” or angle from the side portion of the body of the helicopter, to the area directly surrounding the propeller.

Multiple Mufflers:

Each side of the two component pieces may be separate mufflers. For example, although one bolt able or installable piece, the portion covering the front, side, tail, and bottom of the helicopter may be separate mufflers, installed together as one unified component. Additionally, the portion that is cliffed or v'd may be a separate muffler.

Wind-Sound-Epicenter-Surrounding:

The helicopter produces an epicenter of sound, as noted in the reference document which this application claims priority to. Unlike a standard muffling application which closes an open pipe source, this invention surrounds the epicenter or range of audible sound wave production of the helicopter, thus reducing its audible sound. This allows for silenced military operations in high risk territory.

Discharge/Disengagement Remote Controlling:

The invention contains a switch or button, either located in the cockpit (for piloted applications) or at a remote location (for unmanned locations) which when engaged, causes, electromechanically, the two muffler assemblies to fall of from the helicopter.

The invention may contain windshields, which ideally, are unmuffled portions of the assembly, for visibility, in piloted applications of this invention.

Larger than Surrounded Areas:

As implied, the components are larger in width or length of “covered area” than the portions of the aircraft body they so surround.

Cliff/“v” Design:

The two components (containing multiple mufflers) engulf the surrounded area of the aircraft, and cover the bottom, sides, tail, portion of the front, and as described by “cliff/v”, some portions of area surrounding the propeller. Cliff or v refers to a slanted or angled extension of the assemblies from the transition from the portions surrounding the upper body (front, sides, tail, etc), to the portions surrounding the propeller. When applied to all applicable covered portions of the upper body as surrounded as helicopter, the manifest of the two installed silencing components may reveal as a dish or surrounding “bowl” application. See FIG. 1 wherein the branch or

The invention may contain windshields, which ideally, are unmuffled portions of the assembly, for visibility, in piloted applications of this invention.

As implied, the components are larger in width or length of “covered area” than the portions of the aircraft body they so surround.

What is hereby claimed in this invention is as follows:

1. A component installable to an aircraft comprising or containing at least one sound dampening muffler, surrounding or partially surrounding a portion of the aircraft thus dampening its audible sound.

2. The component of claim 1 wherein the component is larger in width and/or length than the portion of the aircraft or aircraft body covered area that it surrounds.

3. The component of claim 1 installed to an aircraft containing a remote control responsive means of causing the component to disassemble or fall off from the aircraft when the responsive component is so engaged.

4. The component of claim 1 wherein multiple of these said components are assembled to an aircraft to effectively dampen or silence its audible operating sound.

5. The component assembly of claim 4 wherein the assembly and aircraft system contains two said installed sound dampening components.

6. The component of claim 1 wherein the component covers areas surrounding both the aircraft body and propeller, wherein the transitional construction design of the component is cliffed or v'd at a curve or otherwise angle to accommodate partial said surroundation of both portions of the body and propeller operating circumferential area, as a single installed component so configured to cover both areas as a single piece.

7. An aircraft containing at least one sound dampening or reducing muffler surrounding or partially surrounding the aircraft.

8. The aircraft of claim 7 containing multiple said mufflers.

9. The aircraft of claim 8 wherein multiple mufflers are coupled into single installed components.

10. The aircraft of claim 9 wherein the aircraft is installed with two said combination muffler components.

11. The aircraft of claim 8 wherein said mufflers are configured to fall off or dissemble or disconnect from the aircraft when engaged by a remote control responsive switch or component.

12. The aircraft of claim 9 wherein said combination muffler installed components are configured to cover portions of the sides, bottom, propeller area, front, and or tail of the aircraft;
